(19) United States
(12) Patent Application Publication
(10) Pub. No.: US 2011/0029444 A1
(43) Pub. Date: Feb. 3, 2011

(54) PROPERTY SCHEME MANAGEMENT SYSTEM AND METHOD

(76) Inventor: Murray Alistair Cameron, Mosman (AU)

Correspondence Address: LADAS & PARRY LLP, 224 SOUTH MICHIGAN AVENUE, SUITE 1600, CHICAGO, IL, 60604, US

(21) Appl. No.: 12/845,099

(22) Filed: Jul. 28, 2010

(30) Foreign Application Priority Data
Jul. 28, 2009 (AU) 2009903520

(51) Int. Cl. G06Q 50/00

(52) U.S. Cl. 705/314

(57) ABSTRACT

A property scheme management system comprising:

a communications module arranged to receive a user instruction, via a user interface, for initiating a property scheme related task;

a data retrieval module arranged to retrieve at least one business rule relevant to the property scheme related task; and

a processing module arranged to initiate and facilitate completion of the task, in accordance with the at least one retrieved business rule.

### TECHNICAL FIELD

This present invention relates generally to a property scheme management system and method and more particularly, but by no means exclusively, to a web portal providing event and case management functionality for one or more strata schemes.

### BACKGROUND OF THE INVENTION

Managing a strata scheme can be difficult (due to the various tasks that need to be undertaken, often at short notice), and a time consuming and thankless task. Some of the processes required to be executed involve book keeping, facilitating processing of work orders (e.g. repairs, maintenance, etc.), organising and facilitating meetings such as the annual general meeting, among others.

Often, to avoid this sort of burden, owners of a scheme (commonly referred to as the “body corporate”) will collectively employ a strata management company to take responsibility for the aforementioned day to day management functions. However, strata management can often be quite expensive and not always carried out to a suitable standard. It would be advantageous if there was provided an alternative way of facilitating strata management that was both cost effective and which did not overly burden the strata owners.

### SUMMARY OF THE INVENTION

In a first aspect the present invention provides a property scheme management system comprising:

a communications module arranged to receive a user instruction, via a user interface, for initiating a property scheme-related task;

a data retrieval module arranged to retrieve at least one business rule relevant to the property scheme related task; and

a processing module arranged to initiate and facilitate completion of the task in accordance with the at least one retrieved business rule.

In the context of the present specification, the term “property scheme” will be understood as referring to any common term of property associated with a specific association type including but not limited to a strata plan, company title, tenants-in-common, building management committee and community association.

In an embodiment, the task comprises either a work order or scheme-related event.

In an embodiment, the business rules allow the user only to input task related instructions that prescribe with relevant legislation and/or by-laws.

In an embodiment, the business rules are modifiable by one or more authorised users. For example, the authorised users could be executive committee members of the owners corporation or some other authorised property scheme representative.

In an embodiment, the user interface provides at least one pre-populated task option for facilitating task selection. The tasks may be stored in a database coupled to the management system.

In an embodiment, where the task is a scheme-related event, the user interface allows the user to select one or more task items to be considered during the event.

In an embodiment, the user interface allows the user to associate one or more documents pertinent to the selected task items for displaying in association therewith on an event run sheet.

In an embodiment, the user interface further allows the user to specify a number of invitees for the event such that the step of creating the task comprising generating an event run sheet outlining the task items for consideration during the event and either:
(a) communicating the run sheet to the selected invitees; or
(b) allowing the invitees to access the run sheet, via the user interface.

In an embodiment, the event comprises one or more of the following: Annual General Meeting (AGM), Extraordinary General Meeting (EGM), proxy meeting, informal meeting (e.g. clean up day), Executive Committee Meeting, Directors Meeting, Share Holders Meeting, Inaugural General Meeting, First Annual General Meeting, or the like.

In an embodiment, the task items are motions for consideration during the event and wherein the run sheet is an agenda.

In an embodiment, the processing module is further arranged to generate minutes based on run sheet data and any amendment made thereto during creation.

In an embodiment, where the task is a work order, the system allows the user to select from one or more of a plurality of defined case types, via the user interface. In an embodiment the user is further allowed to input an associated work order descriptor that is associated with the work order.

In an embodiment the user is further allowed to input an associated work order descriptor that is associated with the work order.

In an embodiment, the communications module is further arranged to automatically generate and send a request for quote to one or more suppliers selected by the user.

In an embodiment, the communications module is arranged to receive one or more quotes from the selected suppliers and, responsive to receiving authorisation from one or more authorised parties via the user interface, instruct one of the selected suppliers to carry out the work order, based on the received quote.

In an embodiment, the suppliers are selected from a database storing authorised or preferred suppliers.

In an embodiment, a user can inspect or amend a created work order by way of the user interface.

In an embodiment, previously created work orders are displayed in descending order based on status and/or priority.

In accordance with a second aspect, the present invention provides a method for managing a property scheme, the method comprising the steps of utilising a system in accordance with the first aspect to create a strata-related task.

In accordance with a third aspect the present invention provides a computer program code including at least one instruction, which when executed by a processor, implements the system or method according to the first or second aspect.

In accordance with a forth aspect the present invention provides a computer readable medium comprising the program code of the third aspect.

### BRIEF DESCRIPTION OF THE DRAWINGS

Embodiments of the present invention will now be described, by way of example only, with reference to the accompanying drawings, in which:

FIG. 1 is a schematic showing a basic system configuration in accordance with an embodiment;

FIG. 2 is a block diagram of a server arranged implement an embodiment of the present invention;

FIG. 3 is a basic flow diagram showing method steps for creating a strata-related task, in accordance with an embodiment of the present invention;

FIGS. 4a through 4e are flow diagrams showing various process flows for creating and completing various strata-related work orders, in accordance with embodiments of the present invention;

FIG. 5 is an example screen shot of a created work order, in accordance with an embodiment of the present invention;

FIG. 6 is an example screen shot of a graphic user interface for the web server shown in FIG. 2;

FIG. 7 is an example screen shot of an event creation screen in accordance with an embodiment of the present invention;

FIG. 8 is an example screen shot of a user interface for creating a new event in accordance with an embodiment;

FIG. 9 is a screen shot showing selection of a number of event items for consideration during the selected event type;

FIG. 10 is a screen shot of a merged document screen; and

FIG. 11 is a screen shot showing an example run sheet generated in accordance with embodiments of the present invention.

### DETAILED DESCRIPTION OF THE PREFERRED EMBODIMENT

In the following description, embodiments will be described in the context of an on-line management portal for a strata-scheme. However, it will be understood that other property schemes may equally be applicable for use with the present invention, including, for example, company title schemes, tenants-in-common schemes, building management committee schemes and community association schemes.

### Basic System Configuration

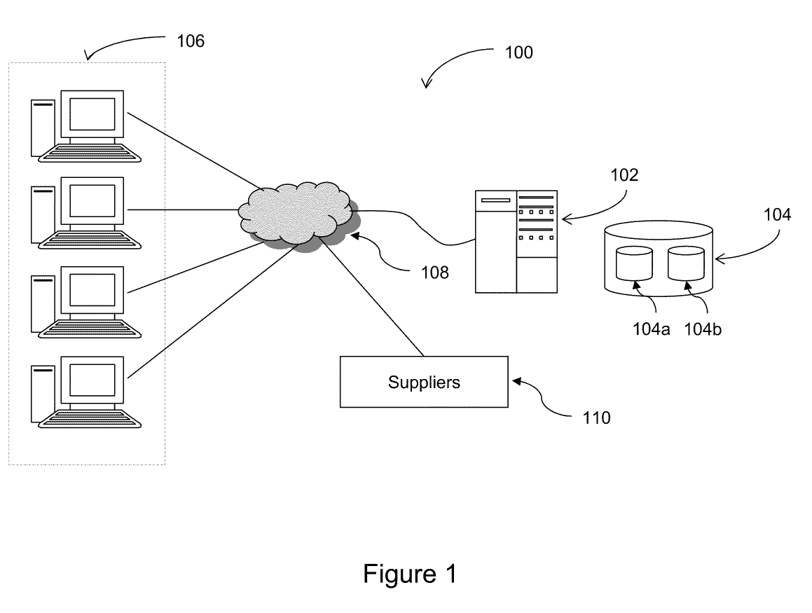

With reference to FIG. 1, there is shown a schematic illustration of a system 100 arranged to implement an embodiment of the present invention. The system 100 includes a web server 102 which provides a strata management web portal. The web portal is operable to access both a case management and event management database 104a, 104b (also maintained by the web server 102) which store case and event management data, respectively. In an embodiment, the stored data includes document templates, regular event types, correspondence for attaching to various strata-related events, data relating to creation of a case or work order, supplier details etc. The other data required to successfully create and facilitate completion of a task, that is, the various business rules, are stored in memory 264 in association with the particular task to which the rules relate. The data stored in the databases 104a, 104b together with the business rule data can be accessed and processed via applications implemented by the web server 102, to create and modify an event or work order, for facilitating strata management. With the aid of a network enabled computer terminal, clients 106 and suppliers 110 may communicate with the web portal via a communications network 108. In the illustrated embodiment, the communications network 108 is in the form of the Internet.

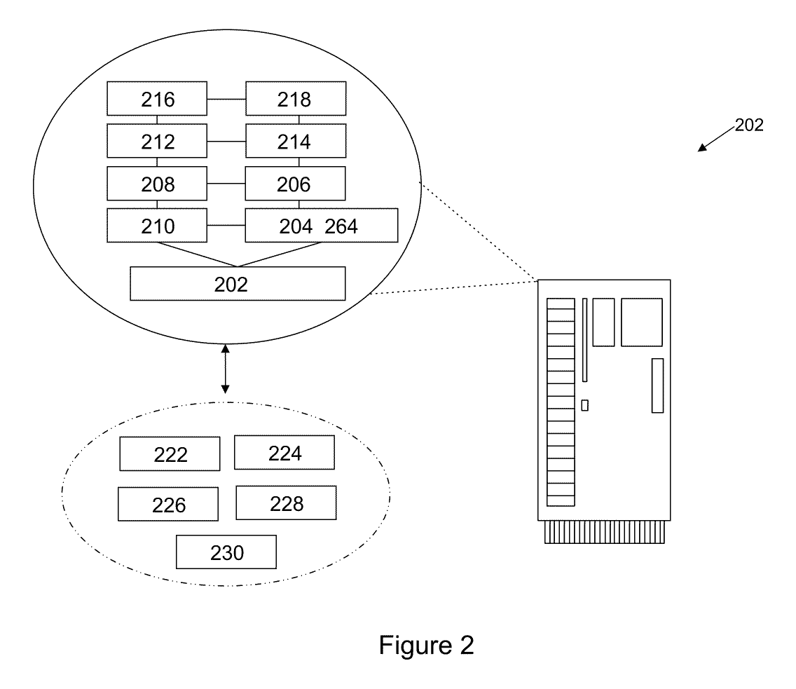

With reference to FIG. 2 there is shown a schematic diagram of the web server 102 illustrating the various modules utilised to carry out strata management aspects. The web server 102 is in the form of a server computing system which may be used specifically to execute applications and/or system services for providing work order and event management functionality (via the browser accessible web portal). The server 102 preferably comprises a processor 202, read only memory (ROM) 204, random access memory (RAM) 206 and input/output devices such as disc drives 208, keyboard 210, mouse 212, display 214, printer 216 and communications device 218. The communications device 218 connects to the communication network 108. It will be understood that, depending on the communications network, the communications device may connect the web server 102 to a computer network, telephone line, an antenna, a gateway or any other type of communications network. Disc drives 208 may include any suitable storage media, such as, for example, floppy disc drives, hard drives, CD ROM drives or magnetic tape drives. The web server 102 may use a single disc drive 208 or multiple disc drives. In addition to the hardware, the server 102 also comprises an operating system, such as Windows XP™ or Unix™. The operating system provides an environment for executing software applications. In this regard, the server 102 implements a server application 222 operable to maintain the web portal.

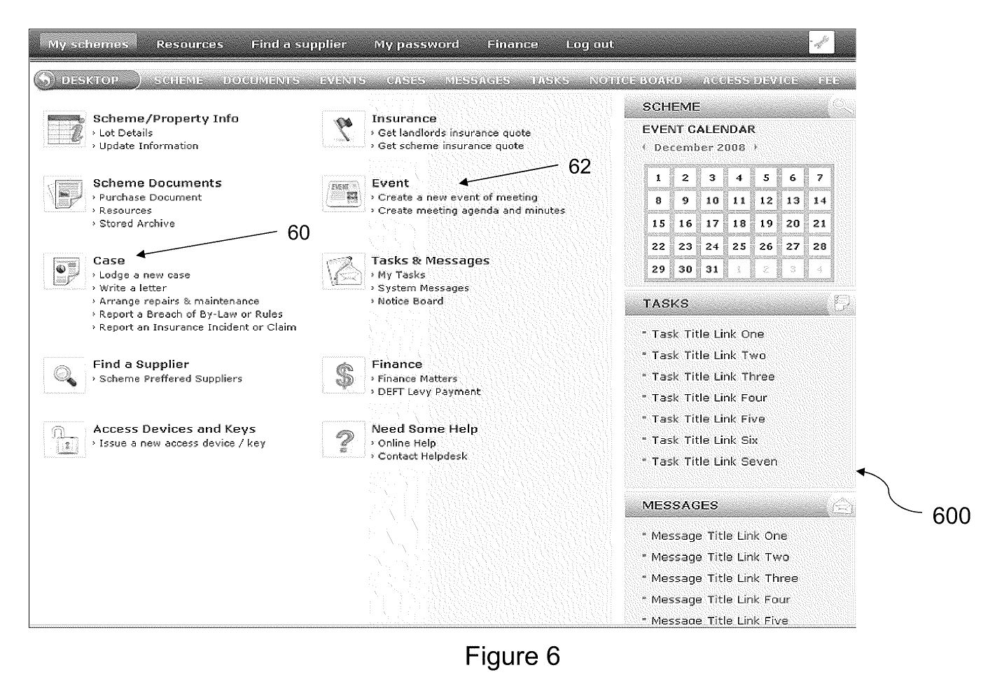

The server application includes a display module 224 arranged to control a graphical user interface displayed on the web site which allows clients access to the system. An example screen shot of a graphic user interface 600 provided by the web page is shown in FIG. 6. A communications module 226 interfaces with the graphical user interface to receive a user instruction for initiating a strata-related task in the form of a work order or scheme-related event. Responsive to receiving the user instruction, a data retrieval module 228 retrieves at least one business rule relevant to the instructed task from the rule store 264 and passes the business-related data together with the strata-related task data to a processing module 230 for initiating and facilitating completion of the task, as will be described in more detail in subsequent paragraphs.

Clients 106, suppliers 110 and any other authorised party can access the web server 102 using any form of network connected user computing device. The user computing device may be in the form of a personal computer comprising typical hardware and software for communicating over the network 108. A browser application residing on the personal computer is operable to allow a user to access the web portal and interact with the user interface, as will be described in more detail below. It will be understood by persons skilled in the art that the user computing device may take the form of any computing device including a personal digital assistant (PDA), blackberry phone, a wireless computing system or any other suitable computing device.

### Basic Process Flow

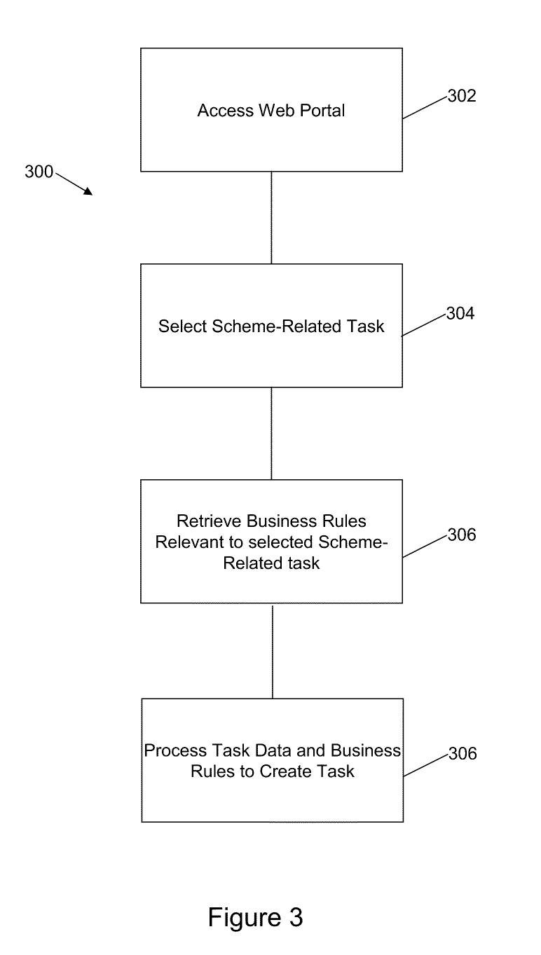

In an embodiment, and with additional reference to FIG. 3, the basic process flow for creating a work order will now be described. The process involves an initial step of a client accessing a web portal maintained by the strata management server 102 (step 302). The next step, step 304, involves the user selecting a particular strata-related task from a list of pre-populated tasks displayed to the user by way of the user interface. At step 306, the web server retrieves business rules relevant to the selected strata-related task from the rule store 264 and passes the retrieved rules together with the task data to the processing module 230. The rules may, for example, specify that a user obtain at least three quotes for a particular work order (e.g. to repair a leaking pipe within the common property), ensure that any selected event particulars prescribe to strata legislation, etc. Finally, at step 308, the processing module 230 processes the rule data and task data to initiate and facilitate completion of the task in accordance with the business rules.

### More Detail of Process Flows

### Creating Work Orders

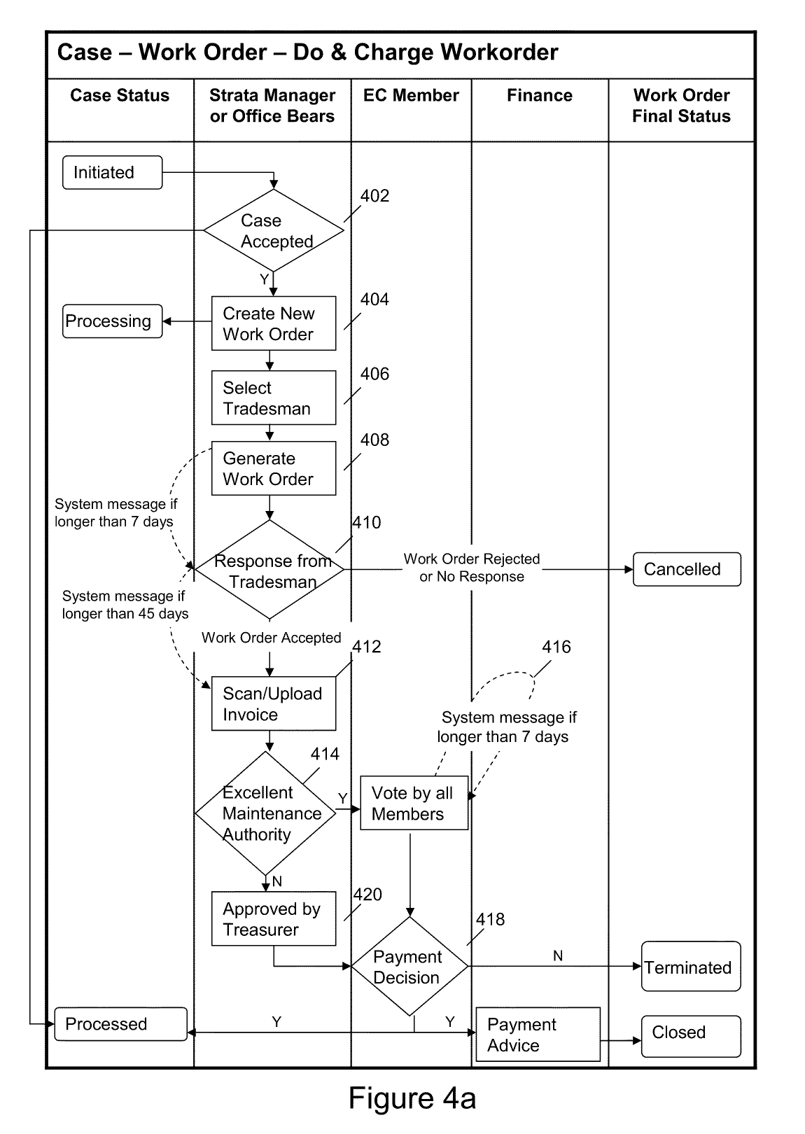

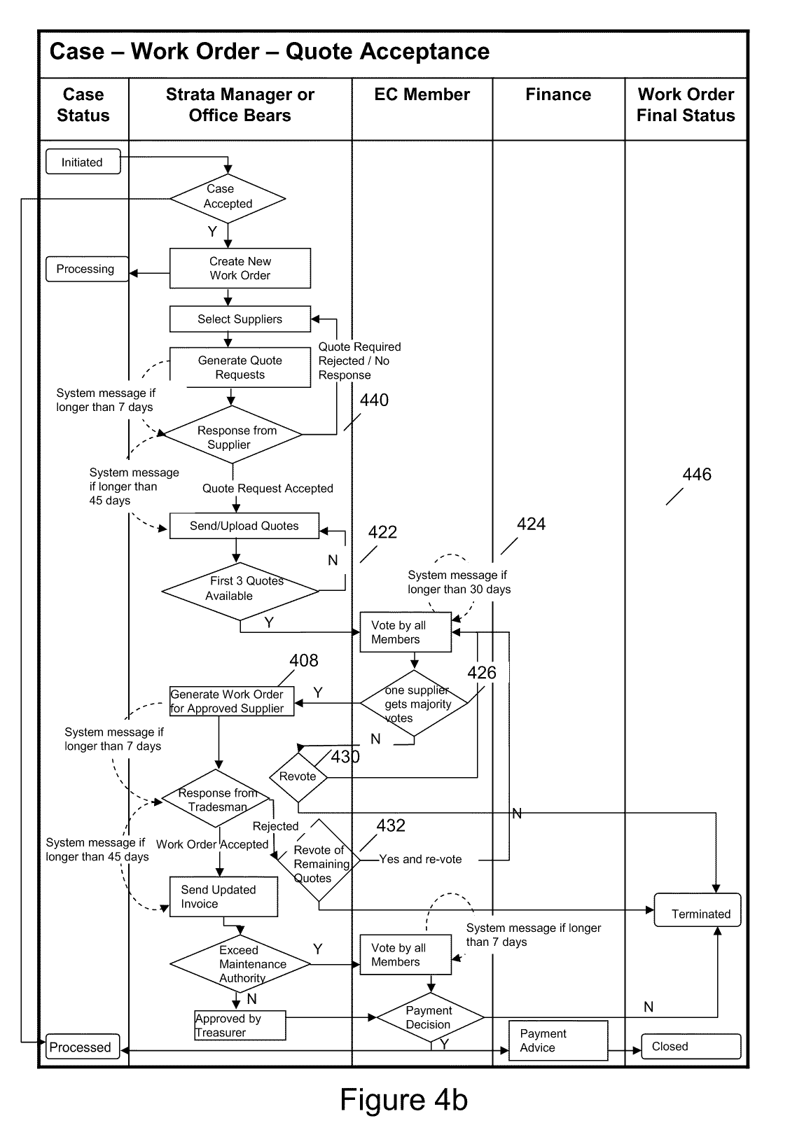

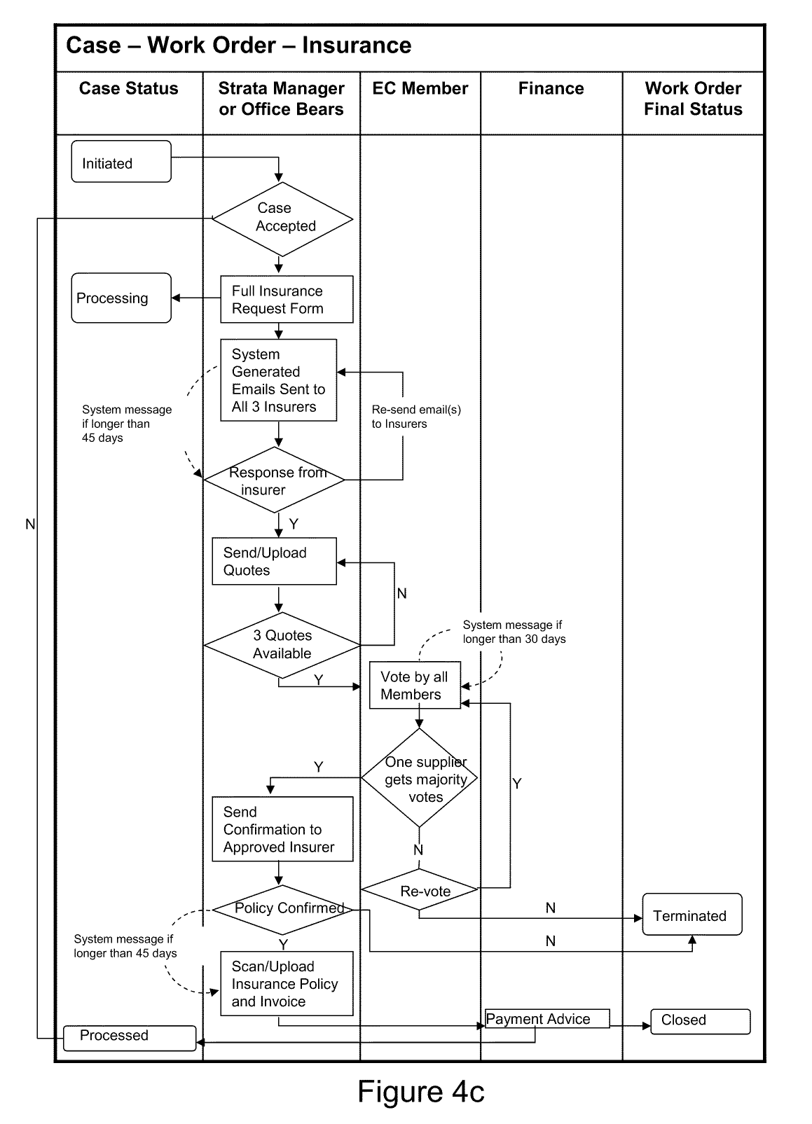

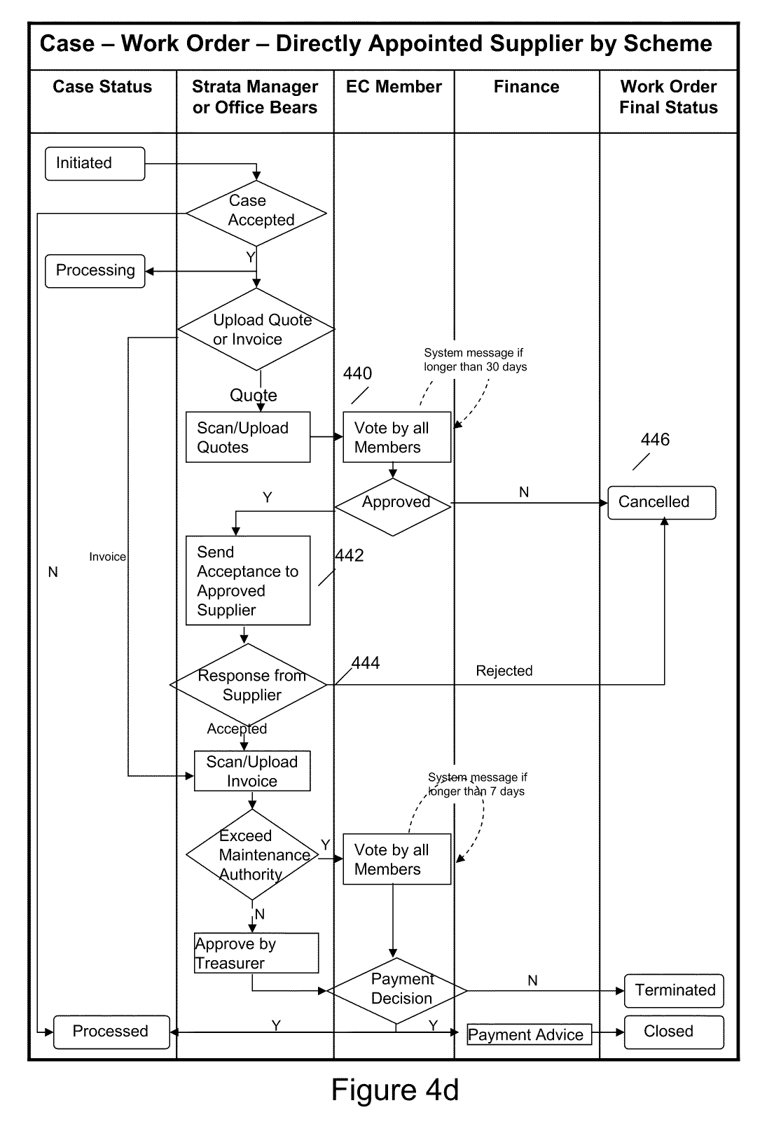

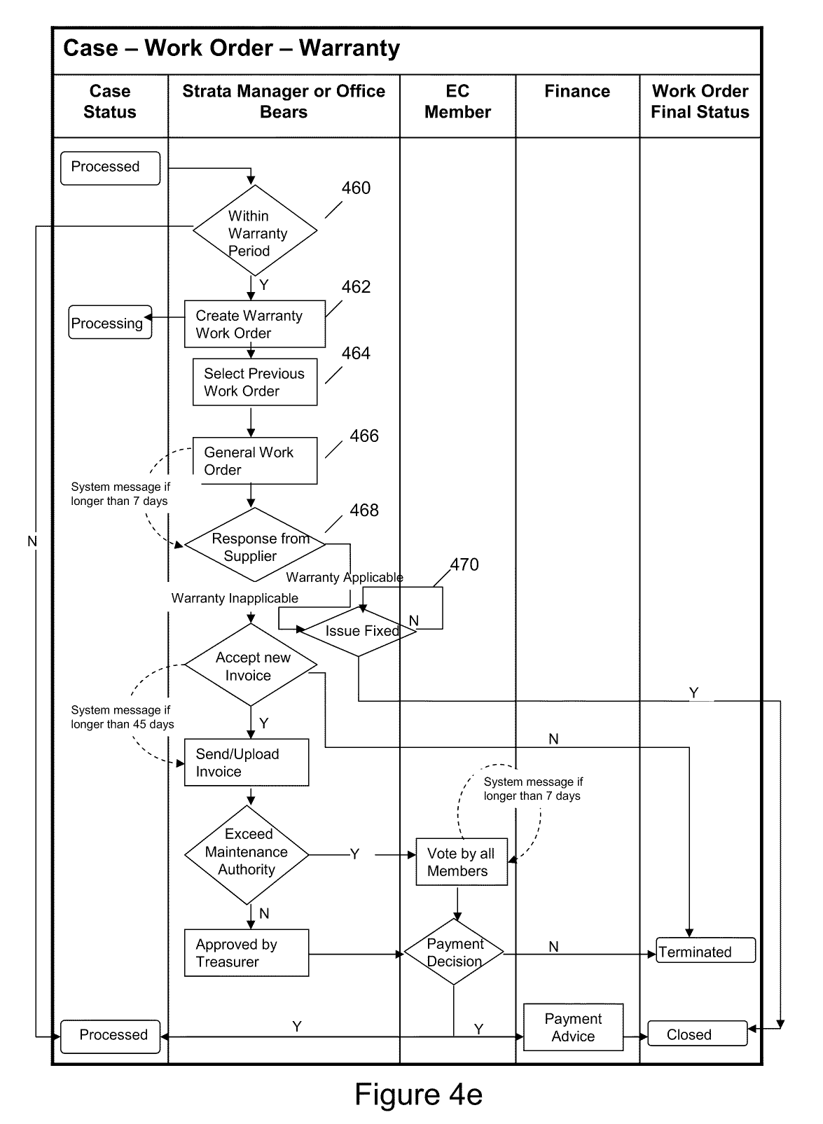

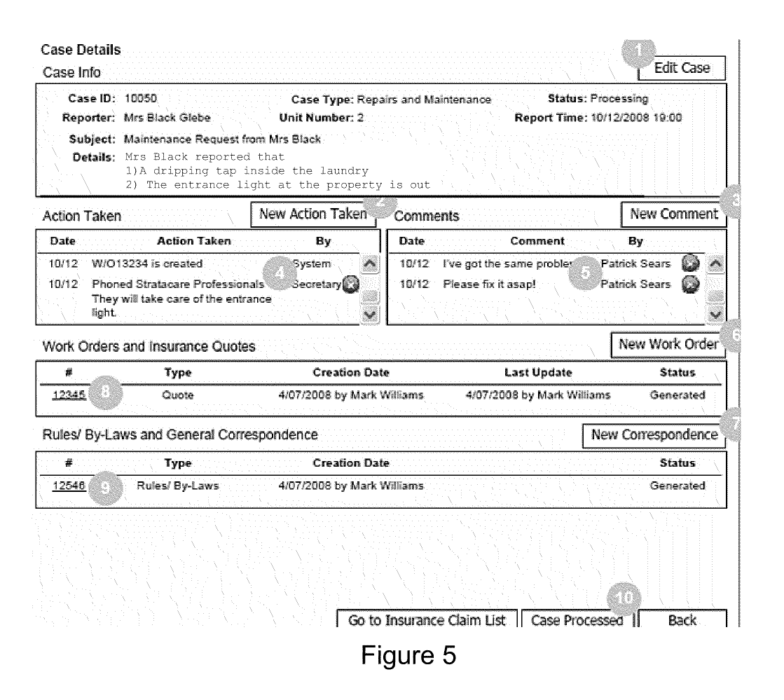

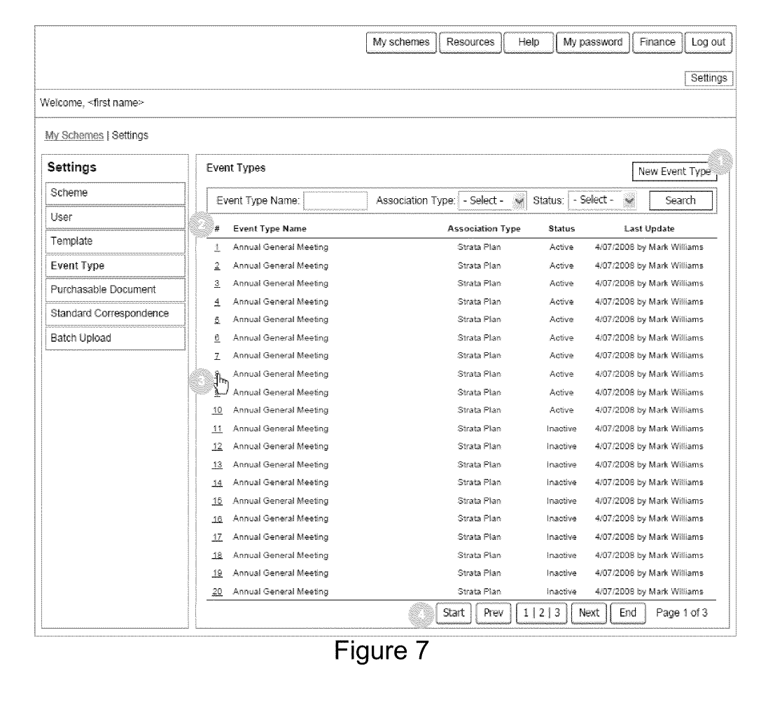

At FIG. 4a there is shown, in more detail, a process for completing a work order, specifically a job work order. With reference to the top left hand portion of the process flow diagram 400, subsequent to a client accessing the work order screen of the web portal (i.e. by selecting the new case button designated by reference numeral 60 in FIG. 6), they are presented with a full list of existing cases displayed in descending order according to their last update (e.g. whether the work order has been processed, modified, or otherwise amended). At step 402, the user selects from one of a plurality of work order case types that are provided in a pre-populated drop down box. The different case types according to one embodiment are repairs and maintenance, rules and by-laws, insurance quote, insurance notification and “other”. An example work order screen shot is shown in FIG. 7.

Once the case type has been selected, at step 406, an authorised user (which may be the client or some other authorised party such as, for example, an executive committee member, strata manager, office bears, etc) selects a supplier or “tradesperson” from a pre-populated list of tradespersons (i.e. details of which are retrieved from the case management database 104a). The tradespersons retrieved from the database 104a and available for selection may, for example, be tradespersons that are located within a specified distance of the client's apartment and who have been stored in association with a particular specialty which is relevant to the selected work order (i.e. plumbers located in Eastern Sydney). The communications module 226 subsequently generates a work order request that is sent to the selected tradesperson for response (step 408). The generated request may be sent electronically, or by way of automated post-out using tradesperson address details that are stored in the case management database 104a in association with the selected tradesperson. At a certain time period (e.g. seven days after lodging the request) the system checks to see whether a response has been received from the selected tradesperson. If no response has been received then the process flow returns to 403 and the client is prompted to select a new supplier (step 406). Alternatively, if a response has been received from the selected tradesperson, the work is carried-out and, once completed, their invoice uploaded and stored in the database 104a (step 412).

At step 414, the system consults the stored business rules to determine whether a maintenance authority has been exceeded (e.g. the tradesperson has issued an invoice that exceeds a threshold amount). If it has, prior to payment, an authorised party (e.g. the executive committee of the owners corporation) will vote on whether to attend to payment, as per steps 416 and 418. Alternatively, if the invoice does not exceed the maintenance authority, then the quote is approved by the treasurer and remittance is issued (step 420 and 422).

With reference to FIG. 4b, there is shown an alternative process flow for creating work orders whereby prior to issuing a work order, business rules dictate that a number of quotes (in this case at least three) from a variety of tradespersons must first be obtained and considered and voted on by authorised strata representatives. As will be noted from FIG. 4b many of the steps are common to FIG. 4a, however a number of additional self explanatory steps 422 to 430 are introduced in-between step 404 and 406 of FIG. 4a.

With reference to FIG. 4c, there is shown a process flow for completing an insurance work order. It will be noted that the basic process flow is very similar to that previously described with reference to FIGS. 4a and 4b, with the exception that rather than selecting a tradesperson, the system selects a predefined number (in this instance three) insurers for the scheme and automatically requests a quote from each. Like FIG. 4b, members are given the opportunity to vote on various quotes received by selected insurers before any policy order is confirmed.

FIG. 4d illustrates a process flow for completing a job work order where the tradesperson has been approached ad hoc (e.g. by one of the unit holders) to either quote or carry out an immediate work order (e.g. such as where an urgent job needs to be undertaken to fix a leaking roof, etc). According to this embodiment, the process effectively begins by uploading the quote or invoice for processing into the system. For the quote embodiment (steps 440 to 444), the processing involves the relevant authorised person(s) voting on the quote before giving the go ahead to carry out the work. If the quote is unacceptable (e.g. quote is excessive), then the tradesperson is given an opportunity to requote on the job. Alternatively, where the work has already been carried out, the authorised person(s) vote to accept and attend to payment of the invoice in much the same manner as outlined in FIG. 4a (see steps 412 to 418).

Lastly, FIG. 4e illustrates a process flow whereby a work order is carried out under warranty. According to this embodiment, by referencing the relevant business rules, the system is arranged to determine whether a job carried out based on a previous work order is still under warranty and, if so, access details of the previous work order (i.e. by searching the database 104a by either job ID, name of tradesperson, etc) in order to generate a new work order to be carried out under warranty (see steps 460 to 466). The tradesperson is then given an opportunity to respond (step 468) based on the claim and either carry out the job under warranty (step 470) or determine that the warranty is either void or not relevant and carry out the job as normal. The subsequent steps are identical to those shown in FIG. 4a with regards to authorisation of the resultant invoice.

### Creating Strata-Related Events

With reference to FIGS. 6 through 11, a methodology for creating a strata-related event will now be described. In order to create a new event, a user accesses an event creation screen provided by the user interface by selecting the event creation button designated by reference numeral 62 shown in FIG. 6. An example screenshot of the event creation interface is shown in FIG. 7. As seen in FIG. 7, once the page is initially loaded, a full list of existing event types will be displayed in descending order of last update. The user will be able to refine the list by using name, association type or status as search criteria. In order to create a new event, the user selects the “new event type” button designated by reference numeral 1.

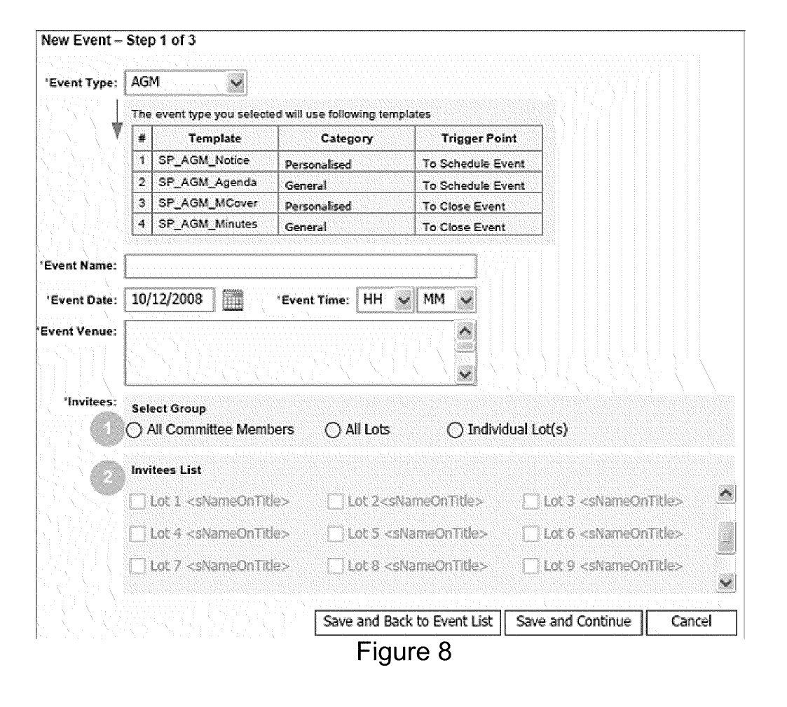

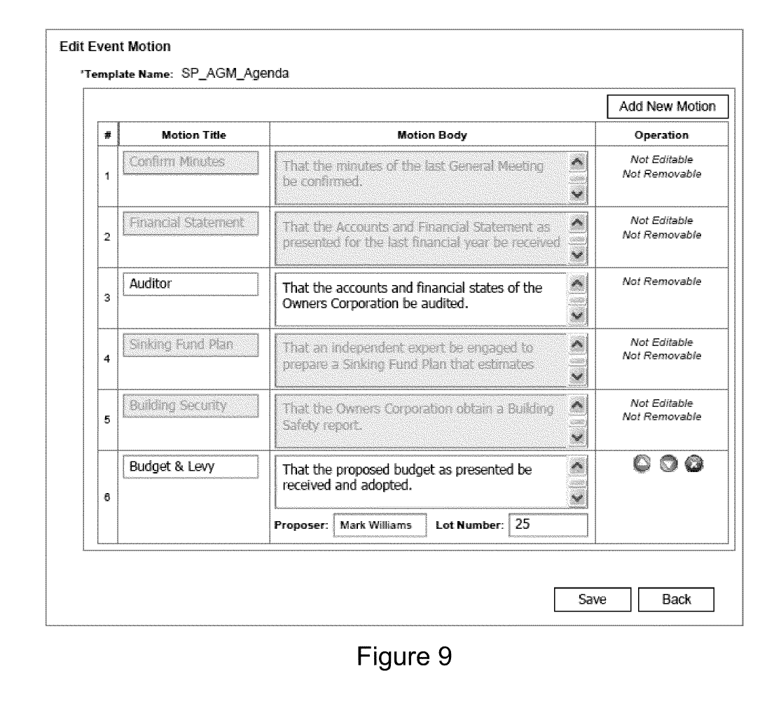

With reference to FIG. 8, after selecting the new event button, the user is presented with a further screen which allows them to select the particular event and timing from a series of drop down boxes. In this instance, the user has selected the annual general meeting event type scheduled for a particular date in the future. The processing module 230 subsequently retrieves a suitable template associated with the selected event type from the event type from the event database 104b for displaying to the user (in this case an agenda template). Each template linked to an event type is either personalised (i.e. contains “merge fields” related to personal profile and therefore each event invitee will have a unique version of the merged document) or general (i.e. no “merge fields” in the template are related to personal profile and therefore event invitee will have an identical version of the merged document). The user is then presented with one or more specific task items to be included in the selected event type. In an embodiment, the business rules dictate the specific task items for including in the event, as required by the relevant law. For example, with reference to FIG. 9, six task items have automatically been selected by the system, namely: confirmed minutes, financial statement, auditor, sinking fund plan, building security and budget and levy. A number of these task items are non-editable, again as controlled by the business rules which dictate the minimum requirements for annual general meeting minutes.

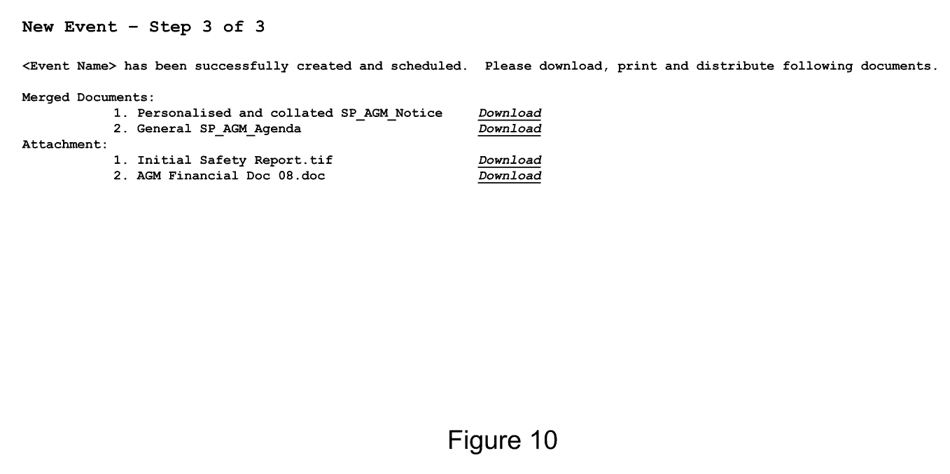

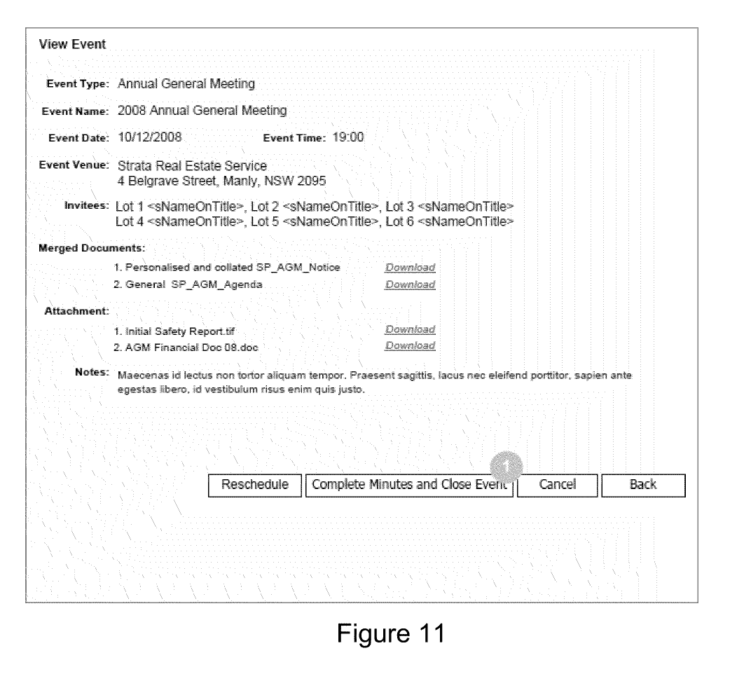

With reference to FIG. 10, there is shown a merged document screen. Once all of the invitees have been selected (see the lower portion of FIG. 8 which allows a user to select invitees associated with the event type), the processing module 230 is operable execute a document merge based on a linked template and supplied data. For each personalised template, the processing module 230 will generate two sets of merged documents in PDF format. The first set will generate one merged document for each invitee. The second set will combine all of the documents generated in the first set into one collated document. Both sets will be stored in PDF format in the event database 104b. For each template of which category is general, the system will generate one merged document. Again, this merged document will be stored in the database in association with the relevant event information. Once merged documents are generated, the processing module 230 will redirect an event creator to allow selected invitees to download merged documents and uploaded attachments. Alternatively, in an embodiment, the processing module is arranged to post out the merged documents once they have been successfully stored in the database. An example completed template available for download is shown in FIG. 11. This completes the Agenda event. A corresponding subsequent related Minute event is actioned at a later date (after the notice period has expired) and the minutes recorded using the customised agenda event as the template.

Embodiments of the present invention provide an online “portal” accessible by authorised parties (such as lot owners) associated with a property scheme and which is arranged to facilitate scheme-related management functions, specifically work order and event related functions (although it will be understood that in other embodiments, the portal may also provide other functionality including account keeping functionality, sending scheme specific reminders or alerts, providing a notice board, inventory control, among others). A number of distinct advantages arise from the online portal. Firstly, the online portal provides an automated online system for allowing scheme owners to initiate and process every day scheme management related tasks with minimal effort and which at all times ensures compliance with the relevant legislation and by-laws due to the in-built business rule processing. Advantageously, the portal allows access to the system during times where a conventional management service would ordinarily be unavailable (e.g. after close of business) by virtue of the online functionality. A non-limiting summary of the principal advantages provided by the online portal can be found below.
Allow clients to access their own scheme-specific web portal.
Allow clients to access their scheme-related information 24/7.
Allow clients to save a great deal of money in management fees by doing some or all of the management functions themselves.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A property scheme management system comprising:
a communications module arranged to receive a user instruction, via a user interface, for initiating a property scheme related task;
a data retrieval module arranged to retrieve at least one business rule relevant to the property scheme related task; and
a processing module arranged to initiate and facilitate completion of the task, in accordance with the at least one retrieved business rule.

2. A property scheme management system in accordance with claim 1, wherein the at least one task comprises either a work order or scheme-related event.

3. A property scheme management system in accordance with claim 1, wherein the at least one business rule allows the user only to input task related instructions that comply with relevant legislation and/or by-laws.

4. A property scheme management system in accordance with claim 1, wherein the business rules are modifiable by one or more authorised users.

5. A property scheme management system in accordance with claim 1, wherein the user interface provides at least one pre-populated task option for facilitating task selection.

6. A property scheme management system in accordance with claim 5, wherein the pre-populated tasks are stored in a database.

7. A property scheme management system in accordance with claim 2, wherein where the task is a scheme-related event, the user interface allows the user to select one or more task items to be considered during the event.

8. A property scheme management system in accordance with claim 7, wherein the user interface further allows the user to associate one or more documents pertinent to the selected task items for displaying in association therewith on an event run sheet.

9. A property scheme strata management system in accordance with claim 7, wherein the user interface further allows the user to specify a number of invitees for the event such that the step of creating the task comprises generating an event run sheet outlining the task items for consideration during the event and either communicating the run sheet to the selected invitees or allowing the invitees to access the run sheet, via the user interface.

10. A property scheme management system in accordance with claim 7, wherein the event comprises one or more of the following Annual General Meeting, Extraordinary General Meeting, proxy meeting, informal meeting, Executive Committee Meeting, Directors Meeting, Share Holders Meeting, Inaugural General Meeting, First Annual General Meeting.

11. A property scheme management system in accordance with claim 7, wherein the task items are motions for consideration during the event and wherein the run sheet is an agenda.

12. A property scheme management system in accordance with claim 11, wherein the processing module is further arranged to generate minutes based on the run sheet and any amendment made thereto during creation.

13. A property scheme management system in accordance with claim 2, wherein where the task is a work order, allowing the user to select from one or more of a plurality of defined case types, via the user interface, and allowing input of an associated work order descriptor.

14. A property scheme management system in accordance claim 13, wherein the case type includes one of the following: repair, maintenance, rules and by-laws, insurance quote, and insurance notification.

15. A property scheme management system in accordance claim 13, wherein the communications module is further arranged to automatically generate and send a request for quote to one or more suppliers selected by the user.

16. A property scheme management system in accordance with claim 15, wherein the communications module is arranged to receive one or more quotes from the selected suppliers and, responsive to receiving authorisation from one or more authorised parties via the user interface, instruct one of the selected suppliers to carry-out the work order, based on the received quote.

17. A property scheme management system in accordance with claim 13, wherein the suppliers are selected from a database storing authorised suppliers.

18. A property scheme management system in accordance with claim 13, wherein a user can inspect a status of a created work order by way of the user interface.

19. A property scheme management system in accordance with claim 18, wherein previously created work orders are displayed in descending order based on status and/or priority.

20. A method for managing a property scheme, the method comprising the steps of utilising a system in accordance with claim 1, to create a strata related task.

21. Computer program code, including at least one instruction, which when executed by a processor, implements the system according to claim 1.

22. A computer readable medium comprising the program code of claim 21.

23. A data signal comprising the program code of claim 21.
